(19) United States
(12) Patent Application Publication
(10) Pub. No.: US 2007/0177395 A1
(43) Pub. Date: Aug. 2, 2007

(54) ARTIFICIAL LIGHTED UMBRELLA TREE

(76) Inventor: Danny Ray Bryant, Dudley, NC (US)

Correspondence Address: WALTER J, TENCZA JR., 10 STATION PLACE, SUITE 3, METUCHEN, NJ, 08840, US

(21) Appl. No.: 11/307,241

(22) Filed: Jan. 27, 2006

(51) Int. Cl. F21S 13/10

(52) U.S. Cl. 362/431

(57) ABSTRACT

An umbrella structure is disclosed with a plurality of lights attached to each of a plurality of arms. The umbrella structure includes a pole and a movable device attached to the pole so that the movable device can slide up and down the pole. The movable device can be moved to move the plurality of arms having the plurality of lights attached thereon.

### FIELD OF THE INVENTION

This invention relates to improved methods and apparatus concerning artificial Christmas trees.

### BACKGROUND OF THE INVENTION

Various artificial Christmas tree devices are known in the art.

### SUMMARY OF THE INVENTION

One embodiment of the present invention provides an umbrella structure with a plurality of lights attached to each of a plurality of arms.

In one embodiment the apparatus includes a pole having a top and a bottom. A movable device is attached to the pole so that the movable device can slide up and down the pole. The apparatus further may include a first arm having a first end fixed near the top of the pole in a manner so that the first arm can pivot with respect to the pole, and a second end opposing the first end of the first arm. The apparatus may also include a second arm having a first end fixed near the top of the pole in a manner so that the second arm can pivot with respect to the pole.

A first member may be provided having a first end and a second end, the first end of the first member fixed to the movable device, the second end of the first member fixed to the first arm between the first and second ends of the first arm. Similarly, a second member may also be provided having a first end and a second end, the first end of the second member fixed to the movable device, the second end of the second member fixed to the second arm between the first and second ends of the second arm. Each of the first and second arms typically includes a plurality of lights.

The first arm may have a length from its first end to its second end. The second end of the first member may be fixed to the first arm at a distance of about two-fifths of the length of the first arm from the first end of the first arm. Similarly, the second arm may have a length from its first end to its second end. The second end of the second member may be fixed to the second arm at a distance of about two-fifths of the length of the second arm from the first end of the second arm. The second end of the first member may be fixed to the first arm by a hinge. The second end of the second member may be fixed to the second arm by a hinge.

The movable device may be comprised of a substantially cylindrical portion, through which the pole passes. The apparatus may be further comprised of a stake device, which can be inserted into the ground. The stake device may have an opening leading to a hollow chamber. The bottom of the pole can be inserted into the stake device through the opening and into the hollow chamber. The stake device may be comprised of a flat disc connected to a substantially cylindrical hollow portion.

The plurality of lights of the first arm may be arranged in a straight line on a member of the first arm. The member of the first arm may include one or more electrical conductors which electrically connect the plurality of lights of the first arm. Similarly, the plurality of lights of the second arm may be arranged in a straight line on a member of the second arm, and the member of the second arm may include one or more electrical conductors which electrically connect the plurality of lights of the second arm. Members of the first and second arms may be rigid. The first member and the second members may be rigid.

An embodiment of the present invention also provides a method including fixing a plurality of lights to a first arm and fixing a plurality of lights to a second arm. The first arm and the second arm may be part of an umbrella structure.

### BRIEF DESCRIPTION OF THE DRAWINGS

FIG. 1 shows a perspective view of an artificial tree apparatus in accordance with an embodiment of the present invention, with the artificial tree apparatus shown in an open state, along with a star ornament and a stake device;

FIG. 2 shows a perspective view of the artificial tree apparatus of FIG. 1, stake device, and star ornament, with the star ornament placed on top of the artificial tree apparatus;

FIG. 3 shows a perspective view of the artificial tree apparatus of FIG. 1, with the artificial tree apparatus shown in closed state; and

FIG. 4 shows a perspective view of another artificial tree apparatus in accordance with another embodiment of the present invention, along with the stake device and the star ornament.

### DETAILED DESCRIPTION OF THE DRAWINGS

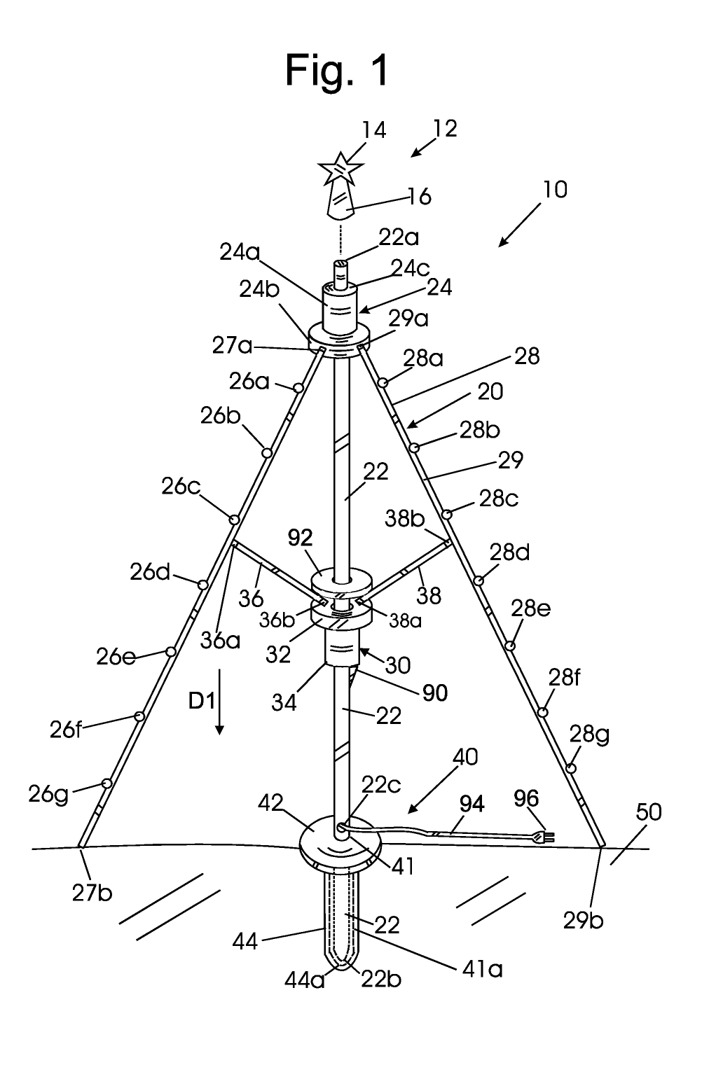

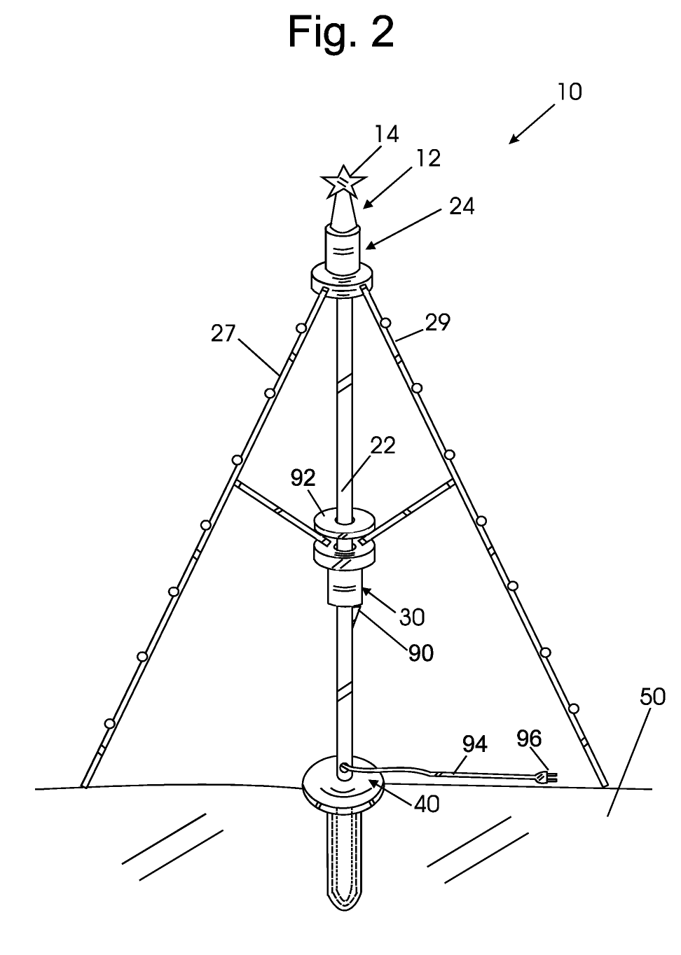

FIG. 1 shows a perspective view of an artificial tree apparatus 10 in accordance with an embodiment of the present invention, with the artificial tree apparatus 10 shown in an open state, along with a star ornament 12 and a stake device 40. FIG. 2 shows a perspective view of the artificial tree apparatus 10 of FIG. 1 with the star ornament 12 placed on top of the artificial tree apparatus 10, along with the stake device 40.

The artificial tree apparatus 10 includes a pole 22, a stationary device 24, and a movable device 30. The artificial tree apparatus 10 also includes limbs, arms, or branches 26 and 28. The limb 26 includes a member 27 and lights 26a, 26b, 26c, 26d, 26e, 26f, and 26g which are attached to member 27. The member 27 may be comprised of a insulated wire or conductor. The wire or conductor of member 27 may electrically connect the lights 26a-26g with a plug, not shown (where would it be ??) so the lights 26a-g can be electrically connected in a closed circuit to a power source, not shown, to light the lights 26a-g. Similarly, the limb 28 includes a member 29 and lights 28a, 28b, 28c, 28d, 28e, 28f, and 28g which are attached to member 29. The member 29 may be comprised of a insulated wire or conductor. The wire or conductor of member 29 may electrically connect the lights 28a-28g with a plug, not shown. (where would it be ??) so the lights 28a-g can be electrically connected in a closed circuit to a power source, not shown, to light the lights 28a-g.

The members 27 and 29, of the limbs 26 and 28, respectively, are connected by members 36 and 38, respectively, to movable device 30. Member 36 is connected by a device 36a to member 27 and by a device 36b to a cylinder portion 32 of movable device 30. Devices 36a and 36b may be hinges. Member 38 is connected by a device 38a to member 29 and by a device 38b to the cylinder portion 32 of movable device 30. Devices 38a and 38b may be hinges.

The movable device 30 may be comprised of the cylinder portion 32 and a cylinder portion 34. There is a an opening or bore 32a running through the center of the movable device 30. The pole 22 passes through the opening or bore 32a.

The pole 22 passes through an opening 24c of the stationary device 24. The stationary device 24 is fixed, with respect to the pole 22, in the position shown in FIG. 1, by adhesive, screws, nails or in any other known manner. The stationary device 24 includes a cylinder portion 24a and a cylinder portion 24b.

The stake device 40 is shown inserted into ground 50 in FIGS. 1 and 2. The stake device includes a disc portion 42 and an elongated portion 44. There is an opening or bore 41 located centrally in the disc portion 42 which leads to a chamber or cavity 41a in the elongated portion 44. An end 22b of the pole 22 can be inserted through the opening or bore 41 and into the chamber or cavity 41a until the end 22b hits a bottom inner surface 44a of the elongated portion 44.

The star ornament 12 includes an attachment device 16 and a star 14. The star 14 may include one or more electrical lights. The top or end 22a of the pole 22 may include an electrical connector. The attachment device 16 may also include an electrical connector. The top or end 22a may electrically connect to the attachment device 16 so that the star 14 can be lit. The electrical cord 94 may be electrically connected the electrical connector located at the top or end 22a of the pole 22 to supply power to one or more lights of the star 14.

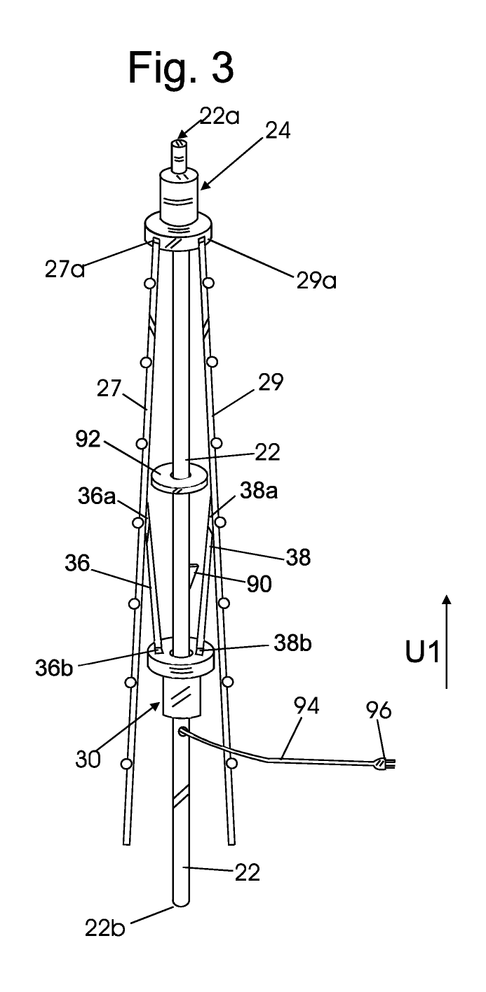

FIG. 3 shows a perspective view of the artificial tree apparatus 10, with the artificial tree apparatus 10 shown in closed state, and without the stake device 40.

The tree apparatus 10 includes a stationary piece 92 fixed to the pole 22 as shown in FIGS. 1-3. The tree apparatus 10 also includes a push button locking device 90, an electrical cord 94 and a plug 96. The plug 96 can be plugged into a standard electrical outlet. The electrical cord 94 comes out of an opening 22c in the pole 22 which is slightly above the location of disk 42 when the bottom end 22b of the pole 22 is completely inserted into the stake device 40 so that the bottom end 22b is touching the bottom inner surface 44a.

In operation, an individual can take the pole 22 out of the stake device 40. The individual would then push the button 90 into a slot, not shown, in the pole 22, and can then pull down on the movable device 30 in the direction D1, shown in FIG. 1, i.e. away from the fixed device 24. If the individual does not push the button 90 into a slot into the pole 22, the movable device 30 will not be able to be moved downwards in the direction D1. After the push button 90 has been pushed into the pole 22 and after the movable device is pulled down in the direction D1, the movable device 30 slides down the pole 22 towards the end 22b. This causes the ends of members 36 and 38, located near the hinges 36b and 38b, respectively, to move down towards end 22b, resulting in the members 36 and 38 pivoting into the position, shown in FIG. 3. In the position of FIG. 3, the members 36 and 38 have pivoted with respect to the members 27 and 29 respectively, so that the members 36 and 38 are nearly parallel to the members 27 and 29, respectively. In the open state of FIG. 1, the members 36 and 38 are substantially perpendicular to the members 27 and 29, respectively. In the closed state shown in FIG. 3, the movable device 30 has slid past the push button device 90 so that the push button device 90 has now expanded outwards again from a slot in the pole 22.

An individual can place the apparatus 10 in an open state by pushing the movable device 30 up in the direction U1, shown in FIG. 3, towards the end 22a. This causes the members 36 and 38 to pivot out and to push the members 27 and 29 into the open position of FIG. 1. As the movable device 30 moves past the push button device 90, the movable device 30 pushes down on the push button device 90, causing 90 to be forced into a slot in the pole 22. After the movable device 30 has passed the push button device 90, the device 90 expands outward again as shown in FIG. 1, and prevents the movable device 30 from sliding back down in the direction D1, keeping the tree apparatus 10 in the open position of FIG. 1.

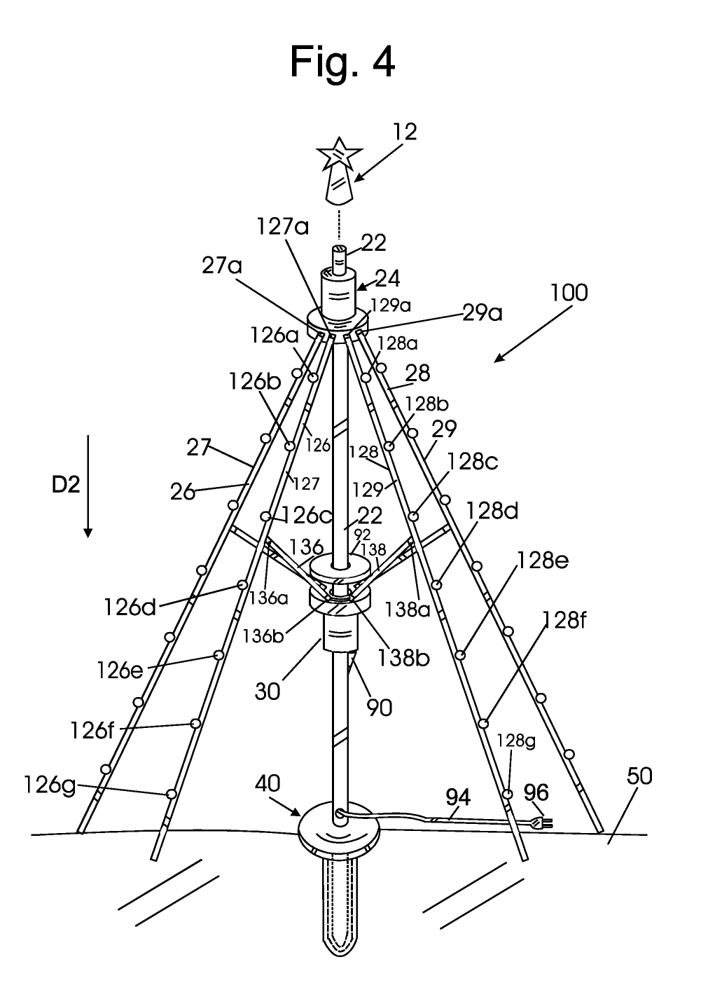

FIG. 4 shows a perspective view of another artificial tree apparatus 100 in accordance with another embodiment of the present invention, along with the star ornament 12 and the stake device 40. The artificial tree apparatus 100 differs from the artificial tree apparatus 10 in that there are four limbs, branches or arms in the apparatus 100 and only two in the apparatus 10. In practice an artificial tree apparatus in accordance with the present invention can include any number of arms.

The apparatus 100 includes the components in FIG. 1 for apparatus 10 and additionally includes arms 126 and 128, which include lights 126a-g and 128a-g, respectively, and members 127 and 129, respectively. The members 127 and 129 are connected to cylinder portion 24b of stationary device 24 by devices 127a and 129a, which may be hinges.

The apparatus 100 also includes members 136 and 138. The member 136 is connected by a device 136a to member 127 and by a device 136b to the cylinder portion 32 of movable device 30. Devices 136a and 136b may be hinges. Member 138 is connected by a device 138a to member 129 and by a device 138b to the cylinder portion 32 of movable device 30. Devices 138a and 138b may be hinges.

In operation, an individual can take the pole 22 shown in FIG. 4, out of the stake device 40. The individual would then push the push button device 90 into a slot in the pole 22 and then can pull down on the movable device 30 in the direction D2, shown in FIG. 4, i.e. away from the fixed device 24. This causes the movable device 30 to slide down the pole 22 towards the end 22b. This also causes the ends of members 36, 38, 136, and 138, located near the hinges 36b, 38b, 136b, and 138b, respectively, to move down towards end 22b, resulting in the members 36, 38, 136, and 138 pivoting into a closed position, similar to that shown in FIG. 3. In the closed position, the members 36, 38, 136, and 138 have pivoted with respect to the members 27, 29, 127, and 129, respectively, so that the members 36, 38, 136, and 138 are nearly parallel to the members 27, 29, 127, and 129 respectively. In the open state of FIG. 4, the members 36, 38, 136, and 138 are substantially perpendicular to the members 27, 29, 127, and 129, respectively.

An individual can change the apparatus 100 from an open state to a closed state, similar to apparatus 10, by pushing the movable device 30 up in a direction towards the end 22a of the pole 22. This causes the members 36, 38, 136, and 138 to pivot out and to push the members 27, 29, 127, and 129 into the open position of FIG. 4. The push button device 90 holds the apparatus 100 in the open position as in the case of the apparatus 10.

The pole 22 may have a length from top or end 22a to bottom or end 22b of about six feet. In the open state of FIG. 1, The width or distance from end 27b to 29b may be approximately four feet. In one embodiment the apparatus 10 or 100 may include or may be replaced by an apparatus having eighteen arms, similar to arms 26, 28, 126, and 128. The pole 22 when closed may measure approximately 7 inches longer than the arms, such as arms 26, 28, 126, and 128. In one embodiment, the pole 22 may be about four feet and the distance between end 27b and 29b may be about three feet. The four foot version may have fourteen arms or spokes, similar to arms 26, 28, 126, and 128. The star ornament 12 may be approximately eight inches from the left to right tip. The plurality of lights such as lights 26a-g, 28a-g, 126a-g, and 128a-g may come in many different colors, such as white, red, blue and green. The electrical cord 94 may run up through the pole 22, which may be hollow, and electrically connect to the arms 26, 126, 28 and 128, and to the lights located on the arms. The electrical cord 94 may also be electrically connected to an electrical connector located at end 22a, which can electrically connect to the attachment device 16 of the star 12. The electrical plug 96 and electrical cord 94 may be encased in weather-resistant plastic.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

What is claimed is:

1. An apparatus comprising:
a pole having a top and a bottom;
a movable device attached to the pole so that the movable device can slide up and down the pole;
a first arm having a first end fixed near the top of the pole in a manner so that the first arm can pivot with respect to the pole, and a second end opposing the first end of the first arm;
a second arm having a first end fixed near the top of the pole in a manner so that the second arm can pivot with respect to the pole;
a first member having a first end and a second end, the first end of the first member fixed to the movable device, the second end of the first member fixed to the first arm between the first and second ends of the first arm;
a second member having a first end and a second end, the first end of the second member fixed to the movable device, the second end of the second member fixed to the second arm between the first and second ends of the second arm;
wherein the first arm includes a plurality of lights; and
wherein the second arm includes a plurality of lights.

2. The apparatus of claim 1 wherein
the first arm has a length from its first end to its second end;
wherein second end of the first member is fixed to the first arm at a distance of about two-fifths of the length of the first arm from the first end of the first arm;
the second arm has a length from its first end to its second end;
and wherein second end of the second member is fixed to the second arm at a distance of about two-fifths of the length of the second arm from the first end of the second arm.

3. The apparatus of claim 1 wherein
the second end of the first member is fixed to the first arm by a hinge; and
the second end of the second member is fixed to the second arm by a hinge.

4. The apparatus of claim 1 wherein
the movable device is comprised of a substantially cylindrical portion, through which the pole passes.

5. The apparatus of claim 1 further comprising
a stake device, which can be inserted into the ground, the stake device having an opening leading to a hollow chamber; and
wherein the bottom of the pole can be inserted into the stake device through the opening and into the hollow chamber.

6. The apparatus of claim 1 wherein
the plurality of lights of the first arm are arranged in a straight line on a member of the first arm, and the member of the first arm includes an electrical conductor which electrically connects the plurality of lights of the first arm; and
wherein the plurality of lights of the second arm are arranged in a straight line on a member of the second arm, and the member of the second arm includes an electrical conductor which electrically connects the plurality of lights of the second arm.

7. The apparatus of claim 1 wherein
the first arm includes a member which is rigid;
the second arm includes a member which is rigid;
the first member is rigid; and
the second member is rigid.

8. The apparatus of claim 6 wherein
the member of the first arm is rigid;
the member of the second arm is rigid;
the first member is rigid; and
the second member is rigid.

9. The apparatus of claim 5 wherein
the stake device is comprised of a flat disc connected to a substantially cylindrical hollow portion.

10. A method comprising
fixing a plurality of lights to a first arm;
fixing a plurality of lights to a second arm;
wherein the first arm has a first end fixed near a top of a pole in a manner so that the first arm can pivot with respect to the pole, and a second end opposing the first end of the first arm;
wherein the second arm has a first end fixed near the top of the pole in a manner so that the second arm can pivot with respect to the pole, and a second end opposing the first end of the first arm;
wherein the pole has a movable device attached to it, so that the movable device can slide up and down the pole;
wherein a first member has a first end which is fixed to the movable device and a second end which is fixed to the first arm between the first and second ends of the first arm; and
wherein a second member has a first end which is fixed to the movable device and a second end which is fixed to the second arm between the first and second ends of the second arm.

11. The method of claim 10 wherein
the first arm has a length from its first end to its second end;
wherein second end of the first member is fixed to the first arm at a distance of about two-fifths of the length of the first arm from the first end of the first arm;
the second arm has a length from its first end to its second end;
and wherein second end of the second member is fixed to the second arm at a distance of about two-fifths of the length of the second arm from the first end of the second arm.

12. The method of claim 10 wherein
the second end of the first member is fixed to the first arm by a hinge; and
the second end of the second member is fixed to the second arm by a hinge.

13. The method of claim 10 wherein
the movable device is comprised of a substantially cylindrical portion, through which the pole passes.

14. The method of claim 10 further comprising
inserting a bottom of the pole into a stake device, which is inserted into the ground, the stake device having an opening leading to a hollow chamber; and
wherein the bottom of the pole can be inserted into the stake device through the opening and into the hollow chamber.

15. The method of claim 10 further comprising
fixing the plurality of lights to the first arm so that they are arranged in a straight line on a member of the first arm; and
fixing the plurality of lights to the second arm so that they are arranged in a straight line on a member of the second arm.

16. The method of claim 10 wherein
the first arm includes a member which is rigid;
the second arm includes a member which is rigid;
the first member is rigid; and
the second member is rigid.

17. The method of claim 15 wherein
the member of the first arm is rigid;
the member of the second arm is rigid;
the first member is rigid; and
the second member is rigid.

18. The method of claim 14 wherein
the stake device is comprised of a flat disc connected to a substantially cylindrical hollow portion.
